(19) United States
(12) Patent Application Publication
(10) Pub. No.: US 2006/0035608 A1
(43) Pub. Date: Feb. 16, 2006

(54) Method and system for using angular hopping in wireless communication systems

(75) Inventors: Guodong Zhang, Farmingdale, NY (US); Jung-Lin Pan, Selden, NY (US); Yingming Tsai, Boonton, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/021,283

(22) Filed: Dec. 23, 2004

Related U.S. Application Data
(60) Provisional application No. 60/600,738, filed on Aug. 11, 2004.

(51) Int. Cl. H04B 1/02; H04B 1/04; H04B 7/02

(52) U.S. Cl. 455/129; 455/101

(57) ABSTRACT

A method and system is disclosed for transmitting signals at particular angles (i.e. angular hopping) thereby decreasing the amount of signals transmitted at angles that result in signals, or instances thereof, being received by a receiver with poor channel conditions. Wireless signals may be transmitted at angles that are randomly selected over time or varied over time according to a predetermined amount. Additionally, where feedback information is provided from a receiver to a transmitter, signals may be transmitted at angles where a receiver has indicated that signals are being received with good channel conditions.

### CROSS REFERENCE TO RELATED APPLICATION(S)

This application claims the benefit of U.S. Patent Application No. 60/600,738, filed Aug. 11, 2004, which is incorporated by reference as if fully set forth.

### FIELD OF INVENTION

The present invention relates to wireless communication systems. More particularly, the present invention relates to improving capacity in wireless communication systems by using angular hopping.

### BACKGROUND

In wireless communication systems, wireless signals transmitted within the system are often subject to scattering. Scattering is where a wireless signal is reflected off of various types of objects resulting in multiple instances of the signal being received at a receiver. Referring now to FIG. 1, a few examples are provided to illustrate how scattering may occur and its effects on wireless communications.

In FIG. 1A, scattering occurs in an area 106 surrounding receiver 104. The scattering may be caused by any type of object (e.g. mountain, building, etc.) and results in a high amount of diversity at the receiver 104 (i.e. receive diversity). Similarly, in FIG. 1B, scattering occurs in an area 108 surrounding a transmit antenna 110 and results in a high amount of diversity at the transmit antenna 110 (i.e. transmit diversity). In FIG. 1C, scattering occurs in an area 112 between a transmit antenna 114 and a receive antenna 116 and results in a high amount of receive diversity. In FIG. 1D, a pico cell 118 is shown wherein scattering occurs throughout the cell 118 and there is a high amount of transmit and receive diversity throughout the cell 118.

Transmit and receive diversity are beneficial to wireless communication systems in that they provide multiple instances of a single signal. This provides multiple instances of the data carried within the signal thereby enhancing a receiver's ability to perform error correction when processing the received data.

A downside of diversity, however, is that some instances of a signal are transmitted with bad channel conditions while other instances of a signal are transmitted with good channel conditions. In current wireless communication systems, receivers capable of receiving multiple instances of a particular signal process all of the received instances regardless of whether they have good channel conditions or bad.

Therefore, in the prior art, the benefits of diversity are not fully optimized in that power and processing resources are wasted on processing instances of signals having poor channel conditions. This arrangement also decreases system capacity in that receive antennas are allocated for reception of signals that do not significantly contribute to extraction of data from the transmitted signal.

It would therefore be desirable to provide a method and system to take advantage of diversity in wireless communication systems by transmitting wireless signals at particular angles.

### SUMMARY

The present invention is a method and system for transmitting signals at particular angles (i.e. angular hopping) thereby decreasing the amount of signals transmitted at angles that result in signals, or instances thereof, being received by a receiver with poor channel conditions. Wireless signals may be transmitted at angles that are randomly selected over time or varied over time according to a predetermined amount. Additionally, where feedback information is provided from a receiver to a transmitter, signals may be transmitted at angles where a receiver has indicated that signals are being received with good channel conditions.

### BRIEF DESCRIPTION OF THE DRAWINGS

A more detailed understanding of the invention may be had from the following description, given by way of example and to be understood in conjunction with the accompanying drawings wherein:

FIGS. 1A, 1B, 1C, and 1D are diagrams showing various examples of scattering in conventional wireless communication systems;

FIG. 2A is a diagram of wireless signals being transmitted from a transmitter at randomly selected angles in accordance with the present invention;

FIG. 2B is a graph of the angles at which the wireless signals in FIG. 2A are being transmitted over time;

FIG. 3A is a diagram of wireless signals being transmitted from a transmitter at angles that are periodically varied according to a predetermined amount in accordance with the present invention;

FIG. 3B is a graph of the angles at which the wireless signals in FIG. 3A are being transmitted over time;

FIG. 4A is a diagram of wireless signals being transmitted at particular angles where a receiver has indicated via feedback information that it is receiving the signals with good channel conditions;

FIG. 4B is a graph of the angles at which the wireless signal in FIG. 4A are being transmitted over time; and

FIG. 5 is a block diagram of an angular hopping transmitter in accordance with the present invention.

### DETAILED DESCRIPTION OF THE PREFERRED EMBODIMENTS

As used herein, a wireless transmit/receive unit (WTRU) includes but is not limited to a user equipment, mobile station, fixed or mobile subscriber unit, pager, or any other type of device capable of operating in a wireless environment. When referred to herein, a base station includes but is not limited to a Node-B, site controller, access point or any other type of interfacing device in a wireless environment. When referred to herein, an antenna may include a plurality of antennas. Further, an antenna may include a plurality of antenna elements.

It is noted that the terminology used when referring to selecting, adjusting, or otherwise manipulating the angles at which signals are transmitted may vary. For example, in the present invention, transmit angles are selected and periodically adjusted to take advantage of diversity to maximize the probability that signals, or instances thereof, are received with good channel conditions. The selection of transmit angles may be referred to as a transmitter's antenna configuration. Antenna configuration also applies to, in multiple-input multiple-output (MIMO) systems for example, the number of antennas selected for transmission (i.e. transmit antenna size), the spacing between antennas, etc. The adjustment of transmit angles may be referred to as dithering (i.e. dithering of a transmitter's current antenna configuration, also referred to as propagation dithering), adjustment of an antenna's gain polarity angle, adjustment of an antenna's angular directional gain, etc.

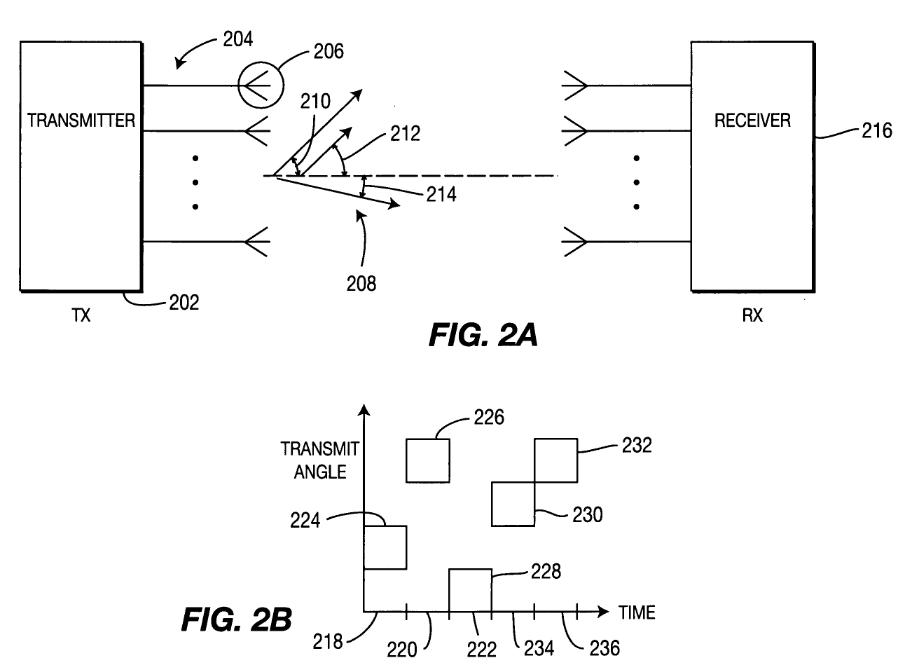

Referring now to FIG. 2A, there is shown a transmitter 202 having a plurality of antennas 204. Each antenna includes a plurality of antenna elements 206. In accordance with the present invention, the transmitter 202 selects a particular antenna configuration and wireless signals 208 are transmitted from the transmitter 202 at particular angles 210, 212, 214. In this embodiment, the angles 210, 212, 214 are randomly selected. By way of example, the angles may be randomly selected using an algorithm. Transmitting the signals 208 at randomly selected angles decreases the probability that any of the signals 208, or instances thereof, are being received at a receiver 216 with poor channel conditions. Referring now to FIG. 2B, where the present invention is implemented in time-slotted communication systems, the angles are preferably varied every timeslot. For example, in timeslot one 218 the signals are transmitted at angle 212, in timeslot two 220 at angle 214, and in timeslot three 222 the signals are transmitted at angle 210 where blocks 224, 226, and 228 correspond to angles 212, 214, and 210, respectively.

A set of randomly selected angles such as 210, 212, 214 may be repeated or a new randomly selected angle may be used in each timeslot. For example, in FIG. 2B, a new randomly selected angle is used in each timeslot. Therefore, new randomly selected angles (blocks 230, 232) are used in timeslots four 234 and five 236 232. In contrast, where a set of randomly selected angles such as 210, 212, 214 are repeated, block 224 would be repeated in timeslot four 234, block 226 in timeslot 236, etc.

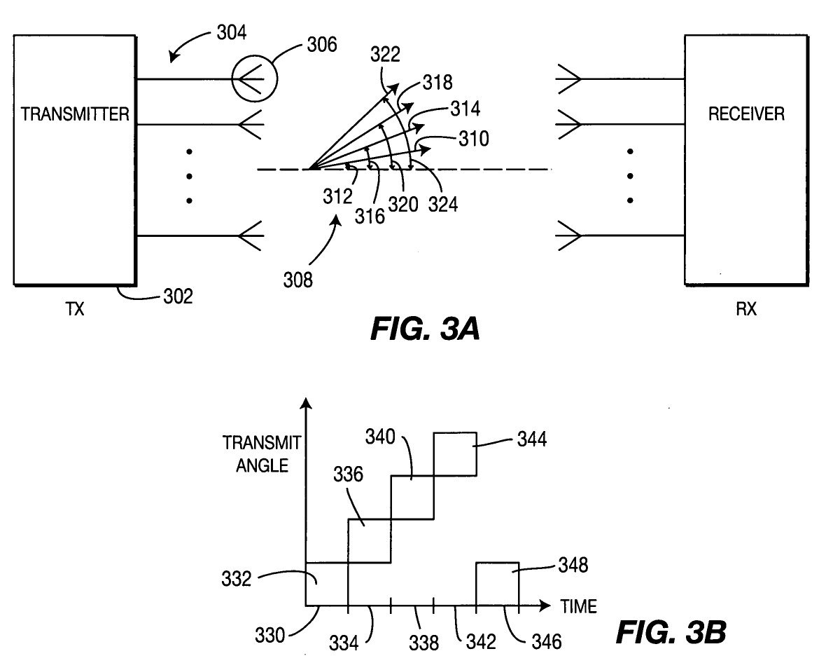

Referring now to FIG. 3A, there is shown a preferred embodiment where transmit angles are periodically varied according to a predetermined amount. A transmitter 302 having multiple antennas 304, wherein each antenna 304 includes a plurality of antenna elements 306, is configured to vary the angle at which it transmits signals 308 by a predetermined amount. Purely by way of example, in FIG. 3A, a first signal 310 is transmitted a particular transmit angle 312 and then the transmit angle is increased three times by a predetermined amount for transmission of a second, third, and fourth signal, respectively. Therefore in this example, a second signal 314 is transmitted at a second transmit angle 316, a third signal 318 is transmitted at a third transmit angle 320, and a fourth signal 322 is transmitted at a fourth transmit angle 324.

Referring now to FIG. 3B, the transmit angles are preferably increased on a per timeslot basis. Therefore, in timeslot one 330, signals (for each antenna 304 of transmitter 302) are transmitted at transmit angle 312 (i.e. block 332). Then, in timeslot two 334, the signals are transmitted at transmit angle 316 (i.e. block 336). Similarly, in timeslots three 338 and four 342, the signals are transmitted at angles 320 and 324 (i.e. blocks 340 and 344, respectively). In timeslot five 346, the transmitter 302 repeats the previous pattern and again transmits its signals at transmit angle 312 (i.e. block 348).

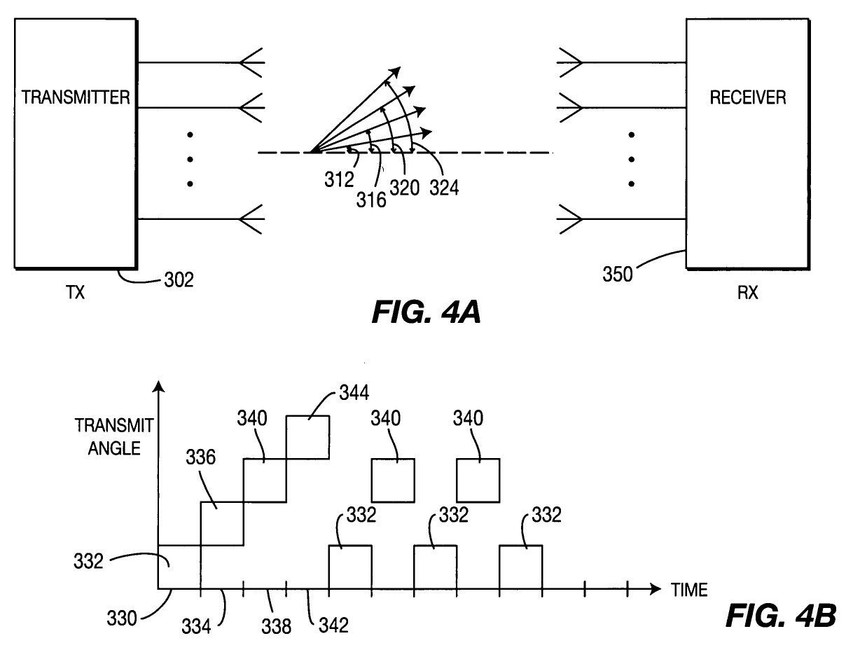

Referring now to FIG. 4A, another preferred embodiment of the present invention is shown. In this embodiment, continuing with the example presented in the above description of FIGS. 3A and 3B, the transmitter 402 is configured to receive feedback information from a receiver 350 regarding channel conditions of signals transmitted from the transmitter 302 and received by the receiver 350. The first four signals are again transmitted at angles 312, 316, 320, and 324. In this embodiment, however, feedback information is provided from the receiver 350. The type of feedback information provided to the transmitter is, for example, any type of quality of service (QoS) measurement. The feedback information enables the transmitter 302 to identify the angles at which signals are being received by the receiver with a satisfactory level of QoS.

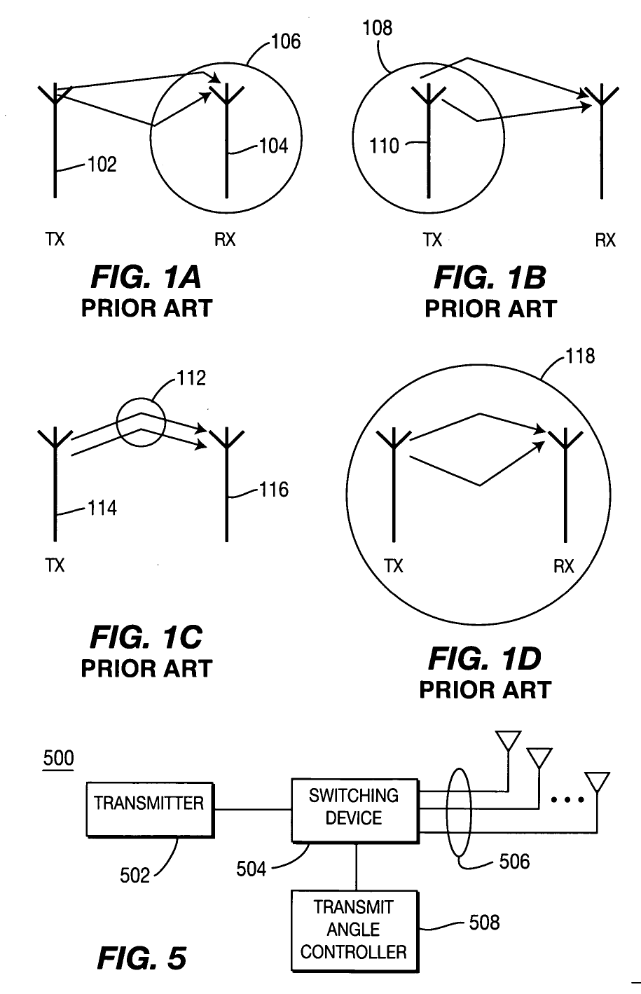

In FIG. 4B, continuing with the example above, signals are transmitted in timeslots 330, 334, 338, and 342 at angles 312, 316, 320, and 324, respectively. Angles 312, 316, 320, and 324 again correspond to blocks 332, 336, 340, and 344. Feedback information provided by the receiver 350 indicates that signals transmitted at transmit angles 312 and 320 are being received by the receiver with a satisfactory QoS while signals transmitted at transmit angles 316 and 324 are not. The transmitter will therefore continue transmitting signals at angles 312 and 320 only. Hence, in FIG. 1B, the transmitter will alternate between blocks 332 and 340.

It is noted that it is preferable to have at least two angles that satisfy the established QoS requirement so that the transmitter 302 may alternate between at least two transmission angles. However, the present invention may be implemented where only a single transmit angle satisfies the QoS requirement and subsequent transmissions are performed at that angle.

In the description above, the same transmit angle is used by a transmitter for all of the transmitter's antennas, per timeslot. The transmitter, however, may use different transmit angles for each of its antennas per timeslot. While it is possible to use different transmit angles, it is preferable to use the same transmit angle. This is because, in the case of different transmit angles, the multipath power delay profiles of different antenna paths may lose synchronization. That is, the antennas may have different delay profiles for the received signals at a receiver site, which may cause performance degradation of diversity gain or increase the complexity of spatial multiplexing at the receiver.

Referring now to FIG. 5, there is shown an angular hopping transmitter 500 in accordance with the present invention. The angular hopping transmitter 500 includes a transmitter 502, a switching device 504, a plurality of antennas 506, and a transmit angle controller 508. The switching device 504 is configured to switch between various transmit angles as indicated by the transmit angle controller 508. The transmit angle controller 508 is configured to control the angles at which the antennas 506 transmit wireless signals. As explained above, the angles may be generated randomly or they may be periodically increased by a predetermined amount.

Further, feedback information may be utilized to lock on to angles wherein the feedback information indicates that signals are being received at acceptable levels of QoS. Where such feedback information is received, the transmit angle controller 508 will utilize only those transmit angles where it has been indicated that signals are being received with an acceptable level of QoS. The various transmit angles output by the transmit angle controller 508 are input to the switching device 504. The switching device 504 then adjusts the transmit angles of the antennas accordingly. It is noted that the switching device 504 may be further configured to control antenna 506 configuration (i.e. antenna size, antenna spacing, etc.). It is noted that feedback information may be utilized where angles are generated randomly or where they are periodically varied.

The angular hopping transmitter 500 may be implemented in any device capable of transmitting signals in a wireless environment. For example, the angular hopping transmitter 500 may be implemented in a base station and/or a WTRU. Additionally, the angular hopping transmitter 500 may be implemented as an integrated circuit in any type of device capable of transmitting signals in a wireless environment. Furthermore, it is noted that the transmit angle may be adjusted in the azimuth, elevation, or a combination of both.

Although the elements in the Figures are illustrated as separate elements, these elements may be implemented on a single integrated circuit (IC), such as an application specific integrated circuit (ASIC), multiple ICs, discrete components, or a combination of discrete components and IC(s). Although the features and elements of the present invention are described in the preferred embodiments in particular combinations, each feature or element can be used alone without the other features and elements of the preferred embodiments or in various combinations with or without other features and elements of the present invention. Furthermore, the present invention may be implemented in any type of wireless communication system.

What is claimed is:

1. In a wireless communication system, a method of selecting antennas to transmit data, the method comprising:
selecting at least one antenna configuration; and
dithering the antenna configuration in a predetermined manner in a repeating fashion.

2. The method of claim 1 wherein the dithering of the antenna configuration effects propagation dithering.

3. The method of claim 1 wherein the dithering of the antenna configuration includes varying antenna gain polarity angle.

4. The method of claim 1 comprising:
the dithering of the antenna configuration including varying the antenna configuration, implemented in a feedback system; and
selecting a set of antenna configuration values in accordance with feedback values and dithering the antenna configuration so as to preferentially include the selected set of antenna configuration values.

5. The method of claim 1 comprising:
the dithering of the antenna configuration including varying the antenna gain polarity angles, implemented in a feedback system; and
selecting a set of antenna gain polarity angles in accordance with feedback values and dithering the antenna configuration so as to preferentially include the selected set of antenna gain polarity angles.

6. The method of claim 1 wherein the dithering of the antenna configuration includes varying polarity angle, implemented in a no-feedback system.

7. The method of claim 1 wherein the dithering of the antenna configuration includes varying antenna configuration values, and being selectively implemented according to a feedback system implementation and a no-feedback system implementation according to availability of feedback data.

8. The method of claim 1 wherein the dithering of the antenna configuration includes:
in a given time, transmitting data with an initial angular directional gain at an angle, θ;
in a subsequent time interval, increasing the transmission angular directional gain by a predetermined value;
repeating the sequence of changing angular directional gain in a sequence of subsequent time intervals; and
subsequent to repeating the sequence of changing angular directional gain delta, resetting the transmission angular directional gain to θ.

9. The method of claim 8 wherein, responsive to availability of channel feedback, estimating a channel condition and determining which transmission angular directional gain provides improved channel quality.

10. The method of claim 1 comprising providing the antenna size as a fixed size.

11. The method of claim 10 comprising:
changing the antenna configuration by re-establishing the antennas; and
performing a propagation dithering sequence, the propagation dithering sequence extending across plural antenna configurations of the same antenna array.

12. The method of claim 11 wherein said propagation dithering sequence provides antenna diversity in an azimuth direction while maintaining a substantially constant elevation direction.

13. The method of claim 11 wherein said propagation dithering sequence provides antenna diversity in both azimuth and elevation directions.

14. The method of claim 1 further comprising establishing antennas from an antenna array including establishing antenna size, such that a configuration of the antennas established from the antenna array establishes the antenna size.

15. The method of claim 14 comprising:
changing the antenna configuration by re-establishing the antennas; and
performing a propagation dithering sequence, the propagation dithering sequence extending across plural antenna configurations of the same antenna array.

16. The method of claim 14 wherein said propagation dithering sequence provides antenna diversity in an azimuth direction while maintaining a substantially constant elevation direction.

17. The method of claim 14 wherein said propagation dithering sequence provides antenna diversity in both azimuth and elevation directions.

18. A multiple in/multiple out (MIMO) wireless communication system comprising:
a circuit for selecting at least one antenna configuration; and
a circuit for dithering the antenna configuration in a predetermined manner in a repeating fashion.

19. An integrated circuit device comprising:
a circuit for selecting at least one antenna configuration; and
a circuit for dithering the antenna configuration in a predetermined manner in a repeating fashion.

20. The integrated circuit device of claim 19 comprising the circuit for dithering of the antenna configuration including a circuit capable of varying the antenna configuration in a feedback system, selecting a set of antenna configuration values in accordance with feedback values, and dithering the antenna configuration so as to preferentially include the selected set of antenna configuration values.
